(19) United States
(12) Patent Application Publication
(10) Pub. No.: US 2023/0419016 A1
(43) Pub. Date: Dec. 28, 2023

(54) Visualized Page Rendering Method, Device, Equipment, and Storage Medium

(71) Applicant: Jingdong Technology Holding Co., Ltd., Beijing (CN)

(72) Inventor: Guanghui Wang, Beijing (CN)

(73) Assignee: Jingdong Technology Holding Co., Ltd., Beijing (CN)

(21) Appl. No.: 18/038,054

(22) PCT Filed: Nov. 9, 2021
(86) PCT No.: PCT/CN2021/129470

§ 371 Date: May 22, 2023

(30) Foreign Application Priority Data
Dec. 31, 2020 (CN) 202011634449.5

(51) Int. Cl. G06F 40/143; G06F 16/958; G06F 16/957; G06F 40/186; G06F 40/117; G06F 40/131

(52) U.S. Cl. CPC G06F 40/143; G06F 16/986; G06F 16/9577; G06F 40/186; G06F 40/117; G06F 40/131

(57) ABSTRACT

A visualized page rendering method includes acquiring the page source data; identifying custom template source data in the page source data; adding the custom template source data to a newly created division (DIV) tag in the page source data to determine a child node set corresponding to the DIV tag; acquiring the external resource referenced by a tag in the child node set and adding the external resource to the DIV tag to obtain first to-be-displayed page data; and rendering and displaying the page based on the first to-be-displayed page data.

This application claims priority to Chinese Patent Application No. 202011634449.5 filed with the China National Intellectual Property Administration (CNIPA) on Dec. 31, 2020, the disclosure of which is incorporated herein by reference in its entirety.

### TECHNICAL FIELD

Embodiments of the present application relate to the field of computer technology, for example, a visualized page rendering method and apparatus, a device, and a storage medium.

### BACKGROUND

With the rapid development of the mobile Internet and the overall popularity of smartphones, people's lifestyles and consumption patterns change dramatically. Web pages are designed through the latest revised version of hyper markup language 5 (HTML5/H5), which becomes an important way for large enterprises to promote the brand images and attract the attention of audiences.

### SUMMARY

The present application provides a visualized page rendering method and apparatus, a device, and a storage medium to render and display custom template source data, improve the compatibility of the visualized page, and quickly load and render the visualized page.

The present application provides a visualized page rendering method. The method includes the steps below.

The page source data is acquired. The page source data includes data in multiple hyper markup language (HTML) files corresponding to multiple modules in a to-be-displayed page respectively.

Custom template source data in the page source data is identified. The custom template source data is data in an HTML file referencing an external resource.

The custom template source data is added to a newly created division (DIV) tag in the page source data to determine the child node set corresponding to the DIV tag.

The external resource referenced by a tag in the child node set is acquired, and the external resource is added to the DIV tag, so that first to-be-displayed page data is obtained.

The page is rendered and displayed based on the first to-be-displayed page data.

The present application also provides a visualized page rendering apparatus. The apparatus includes a first acquisition module, an identification module, a first determination module, a first adding module, and a first display module.

The first acquisition module is configured to acquire the page source data. The page source data includes data in the multiple hyper markup language (HTML) files corresponding to the multiple modules in a to-be-displayed page respectively.

The identification module is configured to identify the custom template source data in the page source data. The custom template source data is the data in the HTML file referencing the external resource.

The first determination module is configured to add the custom template source data to the newly created DIV tag in the page source data to determine the child node set corresponding to the DIV tag.

The first adding module is configured to acquire the external resource referenced by the tag in the child node set and add the external resource to the DIV tag to obtain the first to-be-displayed page data.

The first display module is configured to render and display the page based on the first to-be-displayed page data.

The present application also provides a computer device. The device includes a memory, a processor and a computer program stored on the memory and capable of being executed by the processor. When executing the program, the processor performs the preceding visualized page rendering method.

The present application also provides a computer-readable storage medium. The storage medium stores a computer program. When executing the program, a processor performs the preceding visualized page rendering method.

### BRIEF DESCRIPTION OF DRAWINGS

FIG. 1 is a flowchart of a visualized page rendering method according to embodiment one of the present application.

FIG. 2A is a flowchart of a visualized page rendering method according to embodiment two of the present application.

FIG. 2B is a flowchart of another visualized page rendering method according to embodiment two of the present application.

FIG. 3 is a diagram illustrating the structure of a visualized page rendering apparatus according to embodiment three of the present application.

FIG. 4 is a diagram illustrating the structure of a computer device according to embodiment four of the present application.

### DETAILED DESCRIPTION

The present application is described hereinafter in conjunction with drawings and embodiments. The embodiments described herein are merely intended to explain the present application. For ease of description, only a part related to the present application is illustrated in the drawings.

Similar reference numerals and letters indicate similar items in subsequent drawings. Therefore, once an item is defined in one drawing, the item needs no more definition and explanation in the subsequent drawings. Meanwhile, in the description of the present application, the terms including “first”, and “second” are only configured to distinguish the description and are not to be construed as indicating or implying relative importance.

In the related art, when a web page is designed, a template is often unable to adapt to different service requirement scenarios and cannot satisfy diverse service requirements of users. For this reason, a custom template needs to be added during page building. However, a custom template is generally complicated and cannot render a page through a Vue front-end framework. The method for rendering a page with the use of an iframe framework has many disadvantages, such as slow loading of a web page, prone to local confusion, and poor compatibility, and is not suitable for rendering an added custom template.

### Embodiment One

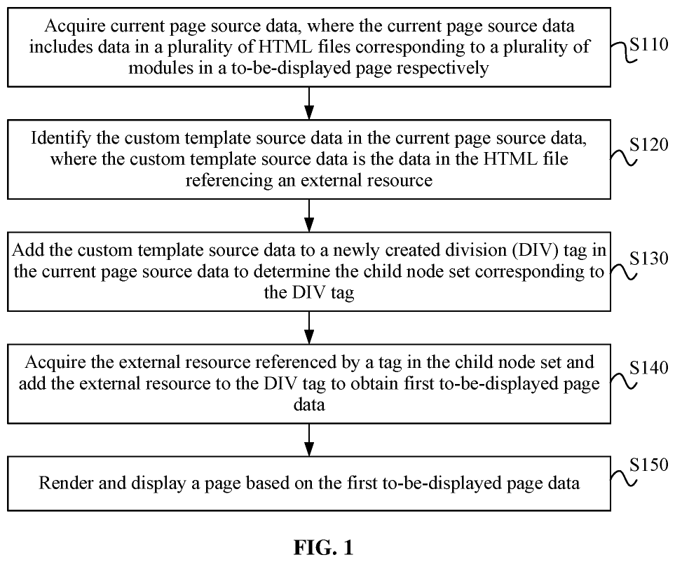

FIG. 1 is a flowchart of a visualized page rendering method according to embodiment one of the present application. This embodiment is applied to the case where a to-be-displayed page is rendered and displayed when the page source data of the to-be-displayed page includes custom template source data. This method may be executed by a visualized page rendering apparatus in this embodiment of the present application. This apparatus may be performed by software and/or hardware. As shown in FIG. 1, this method includes the steps below.

In S110, the current page source data is acquired. The current page source data includes data in the multiple hyper markup language (HTML) files corresponding to the multiple modules in a to-be-displayed page respectively.

The visualized page generally consists of multiple modules. Usually, each module exhibits a function and partitions the function of the visualized page, such as a title module, a content template, and a main menu module. Each module may be built by multiple templates. The data in the multiple HTML files corresponding to the multiple modules in the to-be-displayed page is acquired from a server.

Errors may occur during the downloading and transmission of page data. To ensure the integrity and correctness of the acquired current page source data, message-digest algorithm 5 (MD5) is used to check the current page source data after the current page source data is acquired. MD5 is a widely used hash function that may be used as a unique fingerprint code for a file. The basic principle of MD5 is to generate an MD5 check code by the performance of a hash operation on the current page source data. If the MD5 check code and the MD5 code attached to the page source data are the same, it indicates that received transmission data is complete and correct. If the MD5 check code and the MD5 code attached to the transmission data are different, it is necessary to re-acquire the current page source data.

The generally acquired current page source data is the data encoded by encodeURIComponent. encodeURIComponent is used to convert all characters except letters, numbers, “(”, “)”, “.”, “!”, “˜”, “*”, “′”, “-”, and “_” into Uniform Resource Locators (URLs) in Unicode Transformation Format-8 bit (utf-8). Thus, it is also necessary to invoke decodeURIComponent function to decode the current page source data.

In S120, the custom template source data in the current page source data is identified. The custom template source data is the data in the HTML file referencing an external resource.

The current page source data includes at least custom template source data and may also include at least conventional template source data. The custom template source data is the data in the HTML file referencing the external resource. The data in the multiple HTML files corresponding to the multiple modules in the to-be-displayed page is sequentially loaded and rendered by adopting a parsing sequence from top to bottom. However, based on the principle of browser rendering, the script tag referencing the external resource cannot be loaded and rendered. For this reason, the custom template source data needs to be identified, and the script tag including an src attribute in the custom template source data needs to be processed.

The custom template source data in the current page source data is identified. The custom template source data is the data in the HTML file referencing the external resource. A template identifier (ID) may be used as the unique identifier of the template. The template ID is assigned by the server during the template manufacturing process. A file type indicates the type of the template. For example, “auto-banner” indicates a carousel template, “slide-column” indicates a sliding template, “anchor-nay” indicates an anchor navigation template, and “custom-def” indicates a custom template.

In S130, the custom template source data is added to the newly created DIV tag in the current page source data to determine the child node set corresponding to the DIV tag.

The DIV tag in the HTML file is referred to as a division tag. The DIV tag is marked as <div> in the HTML file and is a block level element used for defining the partition or section in a document. The DIV tag has purity, that is, the DIV tag does not have a default margin tag and padding tag. The margin tag indicates the distance between different elements. The padding tag indicates the distance between the content of an element and the border of the element. For this reason, the custom template source data is added to the newly created DIV tag in the current page source data, so that it is easier to control the display layout of the custom template source data.

The custom template source data is added to the newly created DIV tag in the current page source data, that is, the custom template source data is added between <div> and </div>. The child nodes of the custom template source data in the DIV tag are determined to be a child node set. The child node set represents a sequential node list. The child node set includes a text node and an element node.

In S140, the external resource referenced by a tag in the child node set is acquired, and the external resource is added to the DIV tag, so that first to-be-displayed page data is obtained.

The external resource referenced by the src attribute in the script tag in the child node set is acquired. The src attribute specifies the URL of an external script file. The external resource may be a js file, that is, a web page Java Script client script file. The external resource is added to the DIV tag to obtain the first to-be-displayed page data. If multiple external resources are included, the external resources are sequentially added to the DIV tag from top to bottom according to the positions of the external resources.

For example, the content in the script tag in the child node set may be <script src=“http://www.example.com/example s”></script> or may be <script src “/scripts/example.js”></script>. The content of example.js is added to the DIV tag to obtain the first to-be-displayed page data.

In S150, the page is rendered and displayed based on the first to-be-displayed page data.

The page is rendered and displayed on a browser based on the first to-be-displayed page data.

In the technical solutions of this embodiment, the custom template source data in the current page source data is identified. The custom template source data is added to the newly created DIV tag in the current page source data to determine the child node set corresponding to the DIV tag. The external resource referenced by the tag in the child node set is acquired, and the external resource is added to the DIV tag, so that the first to-be-displayed page data is obtained. The page is rendered and displayed based on the first to-be-displayed page data. In this manner, a custom template can be added during the design of the visualized page to satisfy diverse service requirements of users.

### Embodiment Two

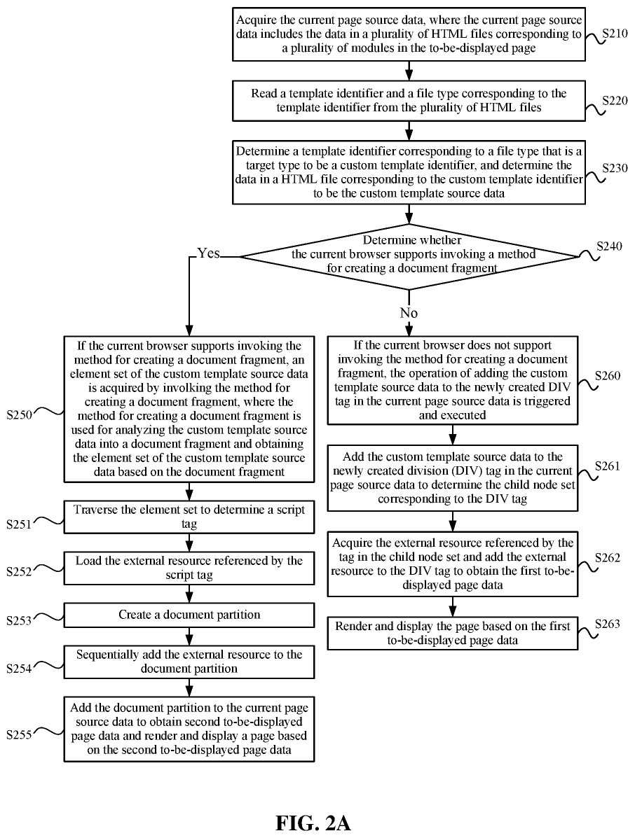

FIG. 2A is a flowchart of a visualized page rendering method according to embodiment two of the present application. Embodiment two is described on the basis of embodiment one. As shown in FIG. 2A, the method includes the steps below.

In S210, the current page source data is acquired. The current page source data includes data in the multiple HTML files corresponding to the multiple modules in a to-be-displayed page respectively.

In S220, a template identifier and a file type corresponding to the template identifier are read from the multiple HTML files.

The current page source data includes at least custom template source data and may also include at least conventional template source data. The custom template source data is the data in the HTML file referencing the external resource. The conventional template data may be rendered and displayed by using the conventional HTML rendering method in the related art. However, for the custom template source data referencing the external resource, since the compatibility of different browsers is different, different rendering methods need to be adopted. In this manner, the visualized page can be quickly loaded and rendered. Furthermore, the custom template source data needs to be first identified from the current page source data.

The INPUT tag of the current page source data is acquired with the use of document.createElement(‘INPUT’) function. The template identifier (ID) and the file type corresponding to the template identifier (ID) are acquired with the use of input.id and input.type respectively.

For example, the INPUT tag of the current page source data is <input id=“template 1” type=“auto-banner”>; <input id=“template2” type=“custom-def”>.

In S230, a template identifier corresponding to a file type that is a target type is determined to be a custom template identifier. The data in the HTML file corresponding to the custom template identifier is determined to be the custom template source data.

The target type is the type of the custom template. The type name is defined as custom-def. If the file type corresponding to the template identifier is custom-def, the template corresponding to the template identifier is determined to be the custom template. The type name of the custom template may be configured according to user requirements and is used to distinguish the custom template from other conventional templates, such as a sliding template and a carousel template.

In S240, it is determined whether the current browser supports invoking a method for creating a document fragment.

The compatibility mode of the browser is queried to determine whether the current browser supports invoking the method for creating a document fragment (createContextualFragment). Invoking the method for creating a document fragment is supported on the IE10+ version browser, while the method for creating a document fragment (createContextualFragment) is not supported on the IE9 version browser or the browser of the iOS9 system and below versions. If the current browser supports invoking the method for creating a document fragment, steps S250 to S255 are executed. If the current browser does not support invoking the method for creating a document fragment, steps S260 to S263 are executed.

In S250, if the current browser supports invoking the method for creating a document fragment, an element set of the custom template source data is acquired by invoking the method for creating a document fragment. The method for creating a document fragment is used for analyzing the custom template source data into a document fragment, and obtaining the element set of the custom template source data based on the document fragment.

The element set (HTMLCollection) of the custom template source data is acquired by invoking the method for creating a document fragment. The HTMLCollection includes all root node tags and root node elements of the custom template source data. The root node tags include a script tag, a LINK tag, and a DIV tag.

In S251, the element set is traversed to determine a script tag.

The HTMLCollection is traversed to determine the script tag and the element of the script tag.

In S252, the external resource referenced by the script tag is loaded.

node.onload( )method is used to load the external resource referenced by the src attribute of the script tag. The external resource is an encapsulation file in js format. js files may be interdependent. Multiple js files may be loaded in sequence when the js files are interdependent.

In this case, it is necessary to load the js files in sequence from top to bottom with the use of a queue.

In S253, a document partition is created.

The js file generally has a large amount of data. There are many problems when large files are directly uploaded in a web page. First, if an error occurs during a long time of uploading, all previous efforts are wasted. Second, the configuration of the server is complicated, and the problem of receiving an extra-large form and timeout should be considered. If a large file is divided into small fragments and loaded and then merged, once the uploading fails, only one fragment is lost, and the entire file does not need to be retransmitted. For this reason, let docF: DocumentFragment=document.createDocumentFragment ( ) function is invoked to create at least one new blank document partition, that is, DocumentFragment.

In S254, the external resource is sequentially added to the document partition.

The external resource is sequentially added to the document partition. Since document fragments exist in a memory and not in a document object model (DOM) tree, when a child element is inserted into the document partition, page backflow may not be caused, so that the performance is optimized.

In S255, the document partition is added to the current page source data to obtain second to-be-displayed page data, and the page is rendered and displayed based on the second to-be-displayed page data.

All child nodes in the document partition are added to the current page source data through appendChild to obtain the second to-be-displayed page data. Only one re-rendering operation occurs in this operation, instead of each node being inserted into the document, and thus multiple re-rendering operations can be avoided.

In S260, if the current browser does not support invoking the method for creating a document fragment, the operation in S261 of adding the custom template source data to the newly created DIV tag in the current page source data is triggered and executed.

If invoking the current browser does not support invoking the method for creating a document fragment, the element set (HTMLCollection) of the custom template source data cannot be acquired by invoking the method for creating a document fragment. For this reason, an instruction is sent to trigger and execute the operation of adding the custom template source data to the newly created DIV tag in the current page source data to acquire the child node set of the custom template source data.

In S261, the custom template source data is added to the newly created DIV tag in the current page source data to determine the child node set corresponding to the DIV tag.

Optionally, the custom template source data is added to the newly created DIV tag in the current page source data to determine the child node set corresponding to the DIV tag in the manners below.

The DIV tag is created in the current page source data.

A root tag element of the custom template source data is added to the DIV tag.

The child node set in the DIV tag is determined according to the root tag element.

A blank DIV tag is created with the use of document.createElement(“div”) function. innerHTML function is invoked to add the root tag element of the custom template source data to the blank DIV tag. The child node set (childNodes) of the root tag element of the custom template source data is determined. The child node set includes a text node and an element node.

Optionally, before the custom template source data is added to the newly created DIV tag in the current page source data, the method also includes the steps below.

A wrong single tag in the custom template source data is determined by regular matching.

The wrong single tag is modified.

If double tags such as html, head, and body are single tags in the custom template source data, loading cannot be performed. The wrong single tag in the custom template source data is determined with the use of the regular matching method singleRE.test( ) The regular expression is singleRE=/\hat{ }<(\w+)\s*V?>(?:<V\1>1)$/. The end tag corresponding to the wrong single tag is added to the element content corresponding to the wrong single tag to ensure that all tags are double tags.

In S262, the external resource referenced by the tag in the child node set is acquired, and the external resource is added to the DIV tag, so that the first to-be-displayed page data is obtained.

Optionally, the external resource referenced by the tag in the child node set is acquired, and the external resource is added to the DIV tag, so that the first to-be-displayed page data is obtained in the manners below.

The child node set is converted into a child node array. The child node array is traversed to determine the script tag. The external resource referenced by the script tag is acquired from the server. The external resource is added to the DIV tag, so that the first to-be-displayed page data is obtained.

Since the child node set (childNodes) is a node list, the traversal method cannot be used. For this reason, Array.prototypr.slice.call may be invoked to convert the child node set (childNodes) into the child node array, and then the child node array may be traversed to determine the src attribute of the script tag. For example, the traversal may be implemented with the use of for Each function. The external resource referenced by the src attribute in the script tag is acquired from the server through a get request. The external resource may be a file encapsulated as js. The external resource is added to the blank DIV tag with the use of innerHTML. If there are multiple js files, the multiple js files are sequentially added to the DIV tag from top to bottom according to the positions of the external resources to obtain the first to-be-displayed page data.

In S263, the page is rendered and displayed based on the first to-be-displayed page data.

As shown in FIG. 2B, the specific steps of this embodiment of the present application are as follows: A developer performs template development on a visualized orchestration personal computer (PC) terminal to obtain a conventional template and a custom template. The development of the conventional template and the development of the custom template are essentially the development of HTML files. An HTML file of the conventional template does not reference an external resource. The user may directly use the conventional template to build a page. An HTML file of the custom template references an external resource, so that the user needs to modify the custom template and then build the page according to a requirement. After data encoding is performed on the developed conventional template and custom template, the developed conventional template and custom template are sent to the server through the application programming interface (API) interface of the server for preprocessing and storage. When the user needs to display the page built by the template on a visualized H5 terminal, the conventional template and the custom template of the to-be-displayed page are acquired from the server. The template source data is parsed and rendered from top to bottom after the MD5 check and data decoding and displayed on the browser. For the conventional template, a conventional rendering method may be used for parsing and rendering. If it is identified that the template type is a custom template, the template source data is parsed in different manners according to the version of the browser, that is, whether the browser supports invoking the method for creating a document fragment (createContextualFragment). If the browser supports invoking the method for creating a document fragment (createContextualFragment), a fragment parsing method is used to parse the template source data. The principle of the fragment parsing method is to acquire the child node set (HTMLCollection) of the template source data by using createContextualFragmen, determine the script tag by traversing HTMLCollection, load the external resource referenced by the src attribute of the script tag, create a document partition, sequentially add the external resource to the document partition, finally, add the document partition to the current page source data to obtain the second to-be-displayed page data, and render and display the page based on the second to-be-displayed page data. If the browser supports invoking the method for creating a document fragment (createContextualFragment), a custom parsing method is used for parsing. The principle of the custom parsing method is to add the custom template source data to the newly created DIV tag in the current page source data to determine the child node set corresponding to the DIV tag, acquire the external resource referenced by the tag in the child node set and add the external resource to the DIV tag to obtain the first to-be-displayed page data, and render and display the page based on the first to-be-displayed page data.

In the technical solutions of this embodiment, the custom template source data in the current page source data is identified. The custom template source data is added to the newly created DIV tag in the current page source data to determine the child node set corresponding to the DIV tag. The external resource referenced by the tag in the child node set is acquired, and the external resource is added to the DIV tag, so that the first to-be-displayed page data is obtained. The page is rendered and displayed based on the first to-be-displayed page data. In this manner, the custom template can be added during the design of the visualized page to satisfy diverse service requirements of users. Moreover, the custom template is rendered in different manners according to the compatibility of the browser. Thus, the compatibility of the visualized page is improved, and the visualized page can be quickly loaded and rendered.

### Embodiment Three

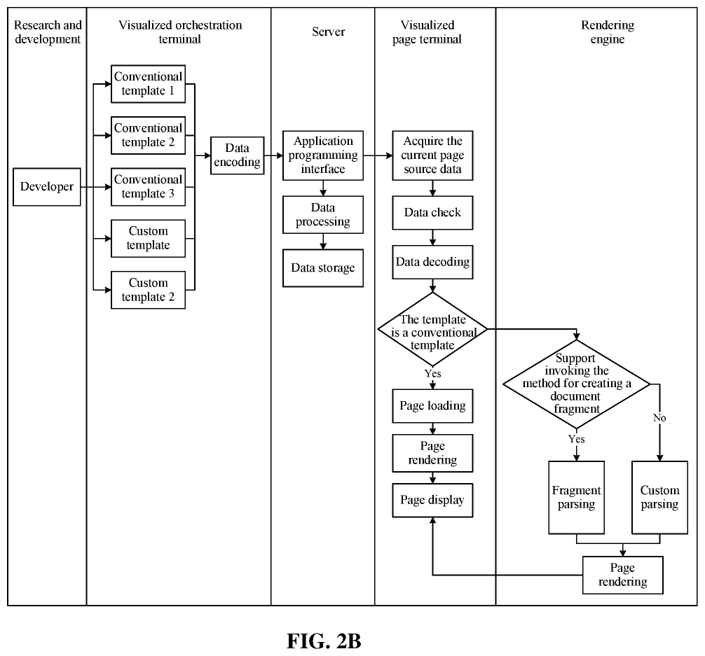

FIG. 3 is a diagram illustrating the structure of a visualized page rendering apparatus according to embodiment three of the present application. This embodiment may be applied to the case where a custom template is rendered in an HTML5 page. This apparatus may be performed by software and/or hardware. The apparatus may be integrated in any device that provides the function of visualized page rendering. As shown in FIG. 3, the visualized page rendering apparatus includes a first acquisition module 310, an identification module 320, a first determination module 330, a first adding module 340, and a first display module 350.

The first acquisition module 310 is configured to acquire the current page source data. The page source data includes the data in the multiple HTML files corresponding to the multiple modules in the to-be-displayed page respectively. The identification module 320 is configured to identify the custom template source data in the current page source data. The custom template source data is the data in the HTML file referencing the external resource. The first determination module 330 is configured to add the custom template source data to the newly created DIV tag in the current page source data to determine the child node set corresponding to the DIV tag. The first adding module 340 is configured to acquire the external resource referenced by the tag in the child node set and add the external resource to the DIV tag to obtain the first to-be-displayed page data. The first display module 350 is configured to render and display the page based on the first to-be-displayed page data.

Optionally, the initialization module 320 includes a first acquisition unit and a determination unit.

The first acquisition unit is configured to read the template identifier and the file type corresponding to the template identifier from the multiple HTML files. The determination unit is configured to determine the template identifier corresponding to the file type that is the target type to be the custom template identifier and determine the data in the HTML file corresponding to the custom template identifier to be the custom template source data. The target type is the type of the custom template.

Optionally, the first determination module 330 includes a creation unit, a first adding unit, and a first determination unit.

The creation unit is configured to create the DIV tag in the current page source data. The first adding unit is configured to add the root tag element of the custom template source data to the DIV tag. The first determination unit is configured to determine the child node set in the DIV tag according to the root tag element.

Optionally, the first adding module 340 includes a conversion unit, a traversal unit, a second acquisition unit, and a second adding unit.

The conversion unit is configured to convert the child node set into the child node array. The traversal unit is configured to traverse the child node array to determine the script tag. The second acquisition unit is configured to acquire the external resource referenced by the script tag from the server. The second adding unit is configured to add the external resource to the DIV tag to obtain the first to-be-displayed page data.

Optionally, the apparatus also includes a matching module and a modification module.

The matching module is configured to, before the custom template source data is added to the newly created DIV tag in the current page source data, determine the wrong single tag in the custom template source data by regular matching. The modification module is configured to modify the wrong single tag.

Optionally, the apparatus also includes a second determination module and a trigger module.

The second determination module is configured to, before the custom template source data is added to the newly created DIV tag in the current page source data, determine whether the current browser supports invoking the method for creating a document fragment.

The trigger module is configured to, if the current browser does not support invoking the method for creating a document fragment, trigger and execute the operation of adding the custom template source data to the newly created DIV tag in the current page source data.

Optionally, the apparatus also includes a second acquisition module, a third determination module, a loading module, a creation module, a second adding module, and a second display module.

The second acquisition module is configured to, if invoking the current browser supports invoking the method for creating a document fragment, acquire the element set of the custom template source data by invoking the method for creating a document fragment. The method for creating a document fragment is used for analyzing the custom template source data into a document fragment and obtaining the element set of the custom template source data based on the document fragment. The third determination module is configured to traverse the element set to determine the script tag. The loading module is configured to load the external resource referenced by the script tag. The creation module is configured to create the document partition. The second adding module is configured to sequentially add the external resource to the document partition. The second display module is configured to add the document partition to the current page source data to obtain the second to-be-displayed page data and render and display the page based on the second to-be-displayed page data.

The preceding product may execute the method provided by any embodiment of the present application and has functional modules and effects corresponding to the method executed.

In the technical solutions of this embodiment, the custom template source data in the current page source data is identified. The custom template source data is added to the newly created DIV tag in the current page source data to determine the child node set corresponding to the DIV tag. The external resource referenced by the tag in the child node set is acquired, and the external resource is added to the DIV tag, so that the first to-be-displayed page data is obtained. The page is rendered and displayed based on the first to-be-displayed page data. In this manner, the custom template can be added during the design of the visualized page to satisfy diverse service requirements of users. Moreover, the custom template is rendered in different manners according to the compatibility of the browser. Thus, the compatibility of the visualized page is improved, and the visualized page can be quickly loaded and rendered.

### Embodiment Four

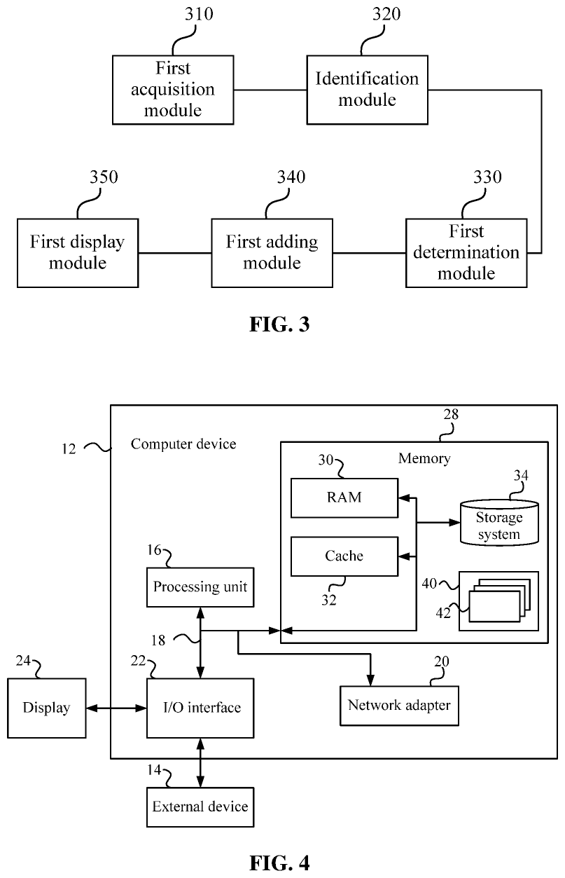

FIG. 4 is a diagram illustrating the structure of a computer device according to embodiment four of the present application. FIG. 4 illustrates a block diagram of an exemplary computer device 12 suitable for implementing the embodiments of the present application. The computer device 12 shown in FIG. 4 is merely an example and should not impose any limitation on the functionality and scope of use of the embodiments of the present application.

As shown in FIG. 4, the computer device 12 is in the form of a general-purpose computing device. The components of the computer device 12 may include, but are not limited to, one or more processors or processing units 16, a system memory 28, and a bus 18 connecting different system components (including the system memory 28 and the processing units 16).

The bus 18 represents one or more of several types of bus structures, including a memory bus or memory controller, a peripheral bus, a graphics acceleration port, a processor, or a local bus using any of multiple bus structures. For example, these architectures include, but are not limited to, an industry subversive alliance (ISA) bus, a micro channel architecture (MAC) bus, an enhanced ISA bus, a video electronics standards association (VESA) local bus, and a peripheral component interconnect (PCI) bus.

The computer device 12 includes a variety of computer system readable media. These media may be any available media that can be accessed by the computer device 12, including volatile and non-volatile media, removable and non-removable media.

The system memory 28 may include a computer system readable medium in the form of a volatile memory, such as a random access memory (RAM) 30 and/or a cache memory 32. The computer device 12 may include other removable/non-removable, volatile/non-volatile computer system storage media. By way of example only, the storage system 34 may be configured to read and write non-removable, non-volatile magnetic media (not shown in FIG. 4, commonly referred to as a “hard disk drive”). Although not shown in FIG. 4, a magnetic disk drive for reading and writing a removable non-volatile disk (for example, a “floppy disk”) and an optical disk drive for reading and writing a removable non-volatile disk, (such as a compact disc read-only memory (CD-ROM), a Digital Video Disc-ROM (DVD-ROM), or other optical media) may be provided. In these cases, each drive may be connected to the bus 18 via one or more data media interfaces. The system memory 28 may include at least one program product having a set (for example, at least one) of program modules configured to perform the functions of each embodiment of the present application.

A program/utility 40 having a set (at least one) of program modules 42, including—but not limited to—an operating system, one or more application programs, other program modules, and program data, may be stored in, for example, the system memory 28. Each or a combination of the embodiments may include an implementation of a network environment. The program module 42 generally performs functions and/or methods in the embodiments described in the present application.

The computer device 12 may also communicate with one or more external devices 14 (such as a keyboard, a pointing device, and a display 24). The computer device 12 may also communicate with one or more devices that enable a user to interact with the computer device 12, and/or with any device (such as a network card and a modem) that enables the computer device 12 to communicate with one or more other computing devices. This communication may be performed through an input/output (I/O) interface 22. In addition, in the computer device 12 of the embodiments, the display 24 is not present as an independent entity, but is embedded in a mirror surface. When the display surface of the display 24 is not displayed, the display surface of the display 24 is visually integrated with the mirror surface. Further, the computer device 12 may also communicate with one or more networks, such as a local area network (LAN), a wide area network (WAN), and/or a public network, such as the Internet, through a network adaptor As shown in the figure, the network adaptor 20 communicates with other modules of the computer device 12 through the bus 18. It should be noted that, although not shown in the figure, other hardware and/or software modules may be used in conjunction with the computer device 12, including, but not limited to, microcode, device drives, redundant processing units, external disk drive arrays, redundant arrays of independent disks (RAID) systems, tape drives, and data backup storage systems.

The processing unit 16 executes various functional applications and data processing by running a program stored in the system memory 28. For example, the visualized page rendering method provided in the embodiments of the present application is implemented. The current page source data is acquired. The current page source data includes the data in the multiple HTML files corresponding to multiple modules in the to-be-displayed page. The custom template source data in the current page source data is identified. The custom template source data is the data in the HTML file referencing the external resource. The custom template source data is added to the newly created DIV tag in the current page source data to determine the child node set corresponding to the DIV tag. The external resource referenced by the tag in the child node set is acquired, and the external resource is added to the DIV tag, so that the first to-be-displayed page data is obtained. The page is rendered and displayed based on the first to-be-displayed page data.

### Embodiment Five

Embodiment five of the present application provides a computer-readable storage medium. The storage medium stores a computer program. When executing the program, a processor performs the visualized page rendering method provided by all the embodiments of the present application of the present application.

The current page source data is acquired. The current page source data includes the data in the multiple HTML files corresponding to multiple modules in the to-be-displayed page. The custom template source data in the current page source data is identified. The custom template source data is the data in the HTML file referencing the external resource. The custom template source data is added to the newly created DIV tag in the current page source data to determine the child node set corresponding to the DIV tag. The external resource referenced by the tag in the child node set is acquired, and the external resource is added to the DIV tag, so that the first to-be-displayed page data is obtained. The page is rendered and displayed based on the first to-be-displayed page data.

Any combination of one or more computer-readable media may be used. The computer-readable media may be computer-readable signal media or computer-readable storage media. The one or more computer-readable storage media may be, but are not limited to, an electrical, magnetic, optical, electromagnetic, infrared or semiconductor system, apparatus or device, or any combination thereof. Examples of the computer-readable storage medium include (non-exhaustive list) an electrical connection having one or more wires, a portable computer magnetic disk, a hard disk, an RAM, an ROM, an erasable programmable read only memory (EPROM or flash memory), an optical fiber, a CD-ROM, an optical memory device, a magnetic memory device, or any suitable combination thereof. In this document, the computer-readable storage medium may be any tangible medium including or storing a program. The program may be used by or used in conjunction with an instruction execution system, apparatus, or device.

A computer-readable signal medium may include a data signal propagated in a baseband or as part of a carrier. Computer-readable program codes are carried in the data signal. The data signal propagated in this manner may be in multiple forms and includes, and is not limited to, an electromagnetic signal, an optical signal, or any suitable combination thereof. The computer-readable signal medium may also be any computer-readable medium except the computer-readable storage medium. The computer-readable medium may send, propagate or transmit a program used by or used in conjunction with an instruction execution system, apparatus or device.

Program codes contained in the computer-readable medium may be transmitted via any suitable medium. The medium includes, but is not limited to, the wireless, a wire, an optical cable, the radio frequency (RF) or the like, or any appropriate combination thereof.

Computer program codes for performing the operations of the present application may be written in one or more programming languages or a combination thereof, the programming languages including object-oriented programming languages such as Java, Smalltalk, C++ and also including conventional procedural programming languages such as programming language or similar programming languages. Program codes may be executed entirely on a user computer, partly on a user computer, as a stand-alone software package, partly on a user computer and partly on a remote computer, or entirely on a remote computer or a server. In the case relate to the remote computer, the remote computer may be connected to the user computer via any kind of network including an LAN or a WAN, or may be connected to an external computer (for example, via the Internet through an Internet service provider).

1. A visualized page rendering method, comprising:
acquiring page source data, wherein the page source data comprises data in a plurality of hyper markup language (HTML) files corresponding to a plurality of modules in a to-be-displayed page respectively;
identifying custom template source data in the page source data, wherein the custom template source data is data in an HTML file of the plurality of HTML files referencing an external resource;
adding the custom template source data to a newly created division (DIV) tag in the page source data to determine a child node set corresponding to the DIV tag;
acquiring an external resource referenced by a tag in the child node set and adding an acquired external resource to the DIV tag to obtain first to-be-displayed page data; and
rendering and displaying a page based on the first to-be-displayed page data.

2. The method according to claim 1, wherein identifying the custom template source data in the page source data comprises:
reading a template identifier and a file type corresponding to the template identifier from the plurality of HTML files; and
determining a template identifier corresponding to a file type that is a target type to be a custom template identifier; and
determining the data in the HTML file corresponding to the custom template identifier to be the custom template source data.

3. The method according to claim 1, wherein adding the custom template source data to the newly created DIV tag in the page source data to determine the child node set corresponding to the DIV tag comprises:
creating the DIV tag in the page source data;
adding a root tag element of the custom template source data to the DIV tag; and
determining the child node set corresponding to the DIV tag according to the root tag element.

4. The method according to claim 1, wherein acquiring the external resource referenced by the tag in the child node set and adding the acquired external resource to the DIV tag to obtain the first to-be-displayed page data comprises:
converting the child node set into a child node array;
traversing the child node array to determine a script tag;
acquiring the external resource referenced by the script tag from a server; and
adding the acquired external resource to the DIV tag to obtain the first to-be-displayed page data.

5. The method according to claim 1, before adding the custom template source data to the newly created DIV tag in the page source data, further comprising:
determining a wrong single tag in the custom template source data by regular matching; and
modifying the wrong single tag.

6. The method according to claim 1, before adding the custom template source data to the newly created DIV tag in the page source data, further comprising:
determining whether a browser supports invoking a method for creating a document fragment;
wherein adding the custom template source data to the newly created DIV tag in the page source data comprising:
in response to a fact that the browser does not support invoking the method for creating the document fragment, triggering and executing an operation of adding the custom template source data to the newly created DIV tag in the page source data.

7. The method according to claim 6, further comprising:
in response to a fact that the browser supports invoking the method for creating the document fragment, acquiring an element set of the custom template source data by invoking the method for creating the document fragment, wherein the method for creating the document fragment is used for analyzing the custom template source data into a document fragment, and obtaining the element set of the custom template source data based on the document fragment;
traversing the element set to determine a script tag;
loading an external resource referenced by the script tag;
creating a document partition;
sequentially adding a loaded external resource to the document partition; and
adding the document partition to the page source data to obtain second to-be-displayed page data and rendering and displaying a page based on the second to-be-displayed page data.

8. (canceled)

9. A computer device, comprising a memory, a processor, and a computer program stored on the memory and capable of being executed by the processor, wherein when executing the program, the processor performs a visualized page rendering method,
wherein the visualized page rendering method comprises:
acquiring page source data, wherein the page source data comprises data in a plurality of hyper markup language (HTML) files corresponding to a plurality of modules in a to-be-displayed page respectively;
identifying custom template source data in the page source data, wherein the custom template source data is data in an HTML file of the plurality of HTML files referencing an external resource;
adding the custom template source data to a newly created division (DIV) tag in the page source data to determine a child node set corresponding to the DIV tag;
acquiring an external resource referenced by a tag in the child node set and adding an acquired external resource to the DIV tag to obtain first to-be-displayed page data; and
rendering and displaying a page based on the first to-be-displayed page data.

10. A computer-readable storage medium, storing a computer program, wherein when executing the computer program, a processor performs a visualized page rendering method,
wherein the visualized page rendering method comprises:
acquiring page source data, wherein the page source data comprises data in a plurality of hyper markup language (HTML) files corresponding to a plurality of modules in a to-be-displayed page respectively;
identifying custom template source data in the page source data, wherein the custom template source data is data in an HTML file of the plurality of HTML files referencing an external resource;
adding the custom template source data to a newly created division (DIV) tag in the page source data to determine a child node set corresponding to the DIV tag;
acquiring an external resource referenced by a tag in the child node set and adding an acquired external resource to the DIV tag to obtain first to-be-displayed page data; and
rendering and displaying a page based on the first to-be-displayed page data.

11. The non-transitory computer-readable storage medium according to claim 10, wherein identifying the custom template source data in the page source data comprises:
reading a template identifier and a file type corresponding to the template identifier from the plurality of HTML files; and
determining a template identifier corresponding to a file type that is a target type to be a custom template identifier; and determining the data in the HTML file corresponding to the custom template identifier to be the custom template source data.

12. The non-transitory computer-readable storage medium according to claim 10, wherein adding the custom template source data to the newly created DIV tag in the page source data to determine the child node set corresponding to the DIV tag comprises:
creating the DIV tag in the page source data;
adding a root tag element of the custom template source data to the DIV tag; and
determining the child node set corresponding to the DIV tag according to the root tag element.

13. The non-transitory computer-readable storage medium according to claim 10, wherein acquiring the external resource referenced by the tag in the child node set and adding the acquired external resource to the DIV tag to obtain the first to-be-displayed page data comprises:
converting the child node set into a child node array;
traversing the child node array to determine a script tag;
acquiring the external resource referenced by the script tag from a server; and
adding the acquired external resource to the DIV tag to obtain the first to-be-displayed page data.

14. The non-transitory computer-readable storage medium according to claim 10, wherein before adding the custom template source data to the newly created DIV tag in the page source data, the visualized page rendering method further comprises:
determining a wrong single tag in the custom template source data by regular matching; and
modifying the wrong single tag.

15. The non-transitory computer-readable storage medium according to claim 10, before adding the custom template source data to the newly created DIV tag in the page source data, wherein the visualized page rendering method further comprises:
determining whether a browser supports invoking a method for creating a document fragment;
wherein adding the custom template source data to the newly created DIV tag in the page source data comprising:
in response to a fact that the browser does not support invoking the method for creating the document fragment, triggering and executing an operation of adding the custom template source data to the newly created DIV tag in the page source data.

16. The non-transitory computer-readable storage medium according to claim 15, wherein the visualized page rendering method further comprises:
in response to a fact that the browser supports invoking the method for creating the document fragment, acquiring an element set of the custom template source data by invoking the method for creating the document fragment, wherein the method for creating the document fragment is used for analyzing the custom template source data into a document fragment, and obtaining the element set of the custom template source data based on the document fragment;
traversing the element set to determine a script tag;
loading an external resource referenced by the script tag;
creating a document partition;
sequentially adding a loaded external resource to the document partition; and
adding the document partition to the page source data to obtain second to-be-displayed page data and rendering and displaying a page based on the second to-be-displayed page data.

17. The computer device according to claim 9, wherein identifying the custom template source data in the page source data comprises:
reading a template identifier and a file type corresponding to the template identifier from the plurality of HTML files; and
determining a template identifier corresponding to a file type that is a target type to be a custom template identifier; and determining the data in the HTML file corresponding to the custom template identifier to be the custom template source data.

18. The computer device according to claim 9, wherein adding the custom template source data to the newly created DIV tag in the page source data to determine the child node set corresponding to the DIV tag comprises:
creating the DIV tag in the page source data;
adding a root tag element of the custom template source data to the DIV tag; and
determining the child node set corresponding to the DIV tag according to the root tag element.

19. The computer device according to claim 9, wherein acquiring the external resource referenced by the tag in the child node set and adding the acquired external resource to the DIV tag to obtain the first to-be-displayed page data comprises:
converting the child node set into a child node array;
traversing the child node array to determine a script tag;
acquiring the external resource referenced by the script tag from a server; and
adding the acquired external resource to the DIV tag to obtain the first to-be-displayed page data.

20. The computer device according to claim 9, wherein before adding the custom template source data to the newly created DIV tag in the page source data, the visualized page rendering method further comprises:
determining a wrong single tag in the custom template source data by regular matching; and
modifying the wrong single tag.

21. The computer device according to claim 9, wherein before adding the custom template source data to the newly created DIV tag in the page source data, the visualized page rendering method further comprises:
determining whether a browser supports invoking a method for creating a document fragment;
wherein adding the custom template source data to the newly created DIV tag in the page source data comprising:
in response to a fact that the browser does not support invoking the method for creating the document fragment, triggering and executing an operation of adding the custom template source data to the newly created DIV tag in the page source data.
